(19) United States
(12) Patent Application Publication
(10) Pub. No.: US 2014/0165406 A1
(43) Pub. Date: Jun. 19, 2014

(54) ELECTRIC SHAVER

(71) Applicant: PANASONIC CORPORATION, Osaka (JP)

(72) Inventors: Hiroaki SHIMIZU, Hikone (JP); Hiroshi SHIGETA, Fujiidera (JP); Shin HOSOKAWA, Hikone (JP); Jyuzaemon IWASAKI, Nagahama (JP)

(73) Assignee: PANASONIC CORPORATION, Osaka (JP)

(21) Appl. No.: 14/103,017

(22) Filed: Dec. 11, 2013

Related U.S. Application Data
(62) Division of application No. 12/649,447, filed on Dec. 30, 2009, now Pat. No. 8,627,574.

(30) Foreign Application Priority Data
Jan. 15, 2009 (JP) 2009-006273

(51) Int. Cl. B26B 19/04

(52) U.S. Cl. CPC B26B 19/048
USPC 30/43.1

(57) ABSTRACT

An electric shaver includes a rod-shaped body part, a head part, and an interposer. The head part projects from one end portion, in a longitudinal direction, of the body part and swingably attached to the body part. The head part includes a shaving portion and a drive mechanism. The interposer is configured to support the head part swingably about a first swing axis parallel with a longitudinal direction of the shaving portion, and to be supported on the body part swingably about a second swing axis orthogonal to the projecting direction of the head part and orthogonal to the first swing axis.

### CROSS REFERENCE TO RELATED APPLICATIONS

The present application is a division of U.S. application Ser. No. 12/649,447, filed Dec. 30, 2009, the disclosures of which incorporated herein by reference in its entirety.

This application is based upon and claims the benefit of priority from the prior Japanese Patent Application No. 2009-006273, filed on Jan. 15, 2009, the entire contents of which are incorporated herein by reference.

### BACKGROUND OF THE INVENTION

1. Field of the Invention

The present invention relates to an electric shaver.

2. Description of the Related Art

Japanese Patent Application Laid-Open Publication No. Hei 6-343776 discloses an electric shaver in which a head part having elongated shaving portions is attached to a tip portion of an approximately rod-shaped body part swingably about two swing axes mutually orthogonal to each other. Each of the two swing axes is approximately orthogonal to a projecting direction of the head part. In addition, one of the two swing axes is parallel with a longitudinal direction of the shaving portions, and the other is orthogonal to the longitudinal direction.

### SUMMARY OF THE INVENTION

In this electric shaver, the two swing axes are located close to each other. Thus, the head part easily swings about the swing axis orthogonal to the longitudinal direction of the shaving portions due to a long moment arm, but has a difficulty in swinging about the swing axis parallel with the longitudinal direction of the shaving portions due to a short moment arm. Because of such swing characteristics of the head part, it is difficult to exert a good following performance of the head part to follow an uneven shaving area, such as the cheeks, chin, or neck. Thereby, the shaving performance may possibly be low.

An object of the present invention is thus to provide an electric shaver including a head part capable of exerting a higher following performance on an uneven shaving area.

An aspect of the present invention is an electric shaver comprising: a rod-shaped body part; a head part projecting from one end portion, in a longitudinal direction, of the body part and swingably attached to the body part, the head part including a shaving portion and a drive mechanism, the shaving portion formed to be elongated in a direction orthogonal to a projecting direction of the head part and having paired blades configured to operate relative to each other, the drive mechanism configured to drive at least one of the paired blades; and an interposer configured to support the head part swingably about a first swing axis parallel with a longitudinal direction of the shaving portion, and to be supported on the body part swingably about a second swing axis orthogonal to the projecting direction of the head part and orthogonal to the first swing axis, wherein the second swing axis is located farther away from a tip portion, in the projecting direction, of a contact surface of the shaving portion to be brought into contact with a shaving area, than the first swing axis is.

According to the aspect, the second swing axis is located farther away from the tip portion, in the projecting direction, of the contact surface of the shaving portion, than the first swing axis is, the contact surface being to be brought into contact with the shaving area. Thus, when the head part swings about the second swing axis, the contact surface moves (slides) a longer distance along the shaving area, which increases the swing resistance. Specifically, when the head part swings about the second swing axis, the swing torque becomes larger as the moment arm becomes longer; however, the swing load torque can be increased by the slide resistance, thereby preventing the head part from swinging easily only about the second swing axis. Consequently, an improved following performance of the head part on the shaving area can be exerted.

The electric shaver may further comprise: a first link mechanism including two first link arms each connected to the interposer and the head part respectively at first connecting axes parallel with the longitudinal direction of the shaving portion, the first link mechanism configured to support the head part on the interposer swingably about the first swing axis; and a second link mechanism including two second link arms each connected to the body part and the interposer respectively at second connecting axes orthogonal to the projecting direction of the head part and orthogonal to the first swing axis, the second link mechanism configured to support the interposer on the body part swingably about the second swing axis. Here, a distance between the first connecting axes for connection of the two first link arms to the interposer may be shorter than a distance between the first connecting axes for connection of the two first link arms to the head part. A distance between the second connecting axes for connection of the two second link arms to the body part may be shorter than a distance between the second connecting axes for connection of the two second link arms to the interposer. An intersection of a first straight line with a second straight line may be located closer to an opposite end portion, in the longitudinal direction, of the body part, than an intersection of a third straight line with a fourth straight line is, the first straight line joining the second connecting axes for one of the two second link arms, the second straight line joining the second connecting axes for the other second link arm, the third straight line joining the first connecting axes for one of the two first link arms, the fourth straight line joining the first connecting axes for the other first link arm.

According to this configuration, for example, with certain arrangement of the first link arms and the second link arms, it is possible to obtain, in a relatively simple manner, a configuration which allows the head part to swing about the first and second swing axes by the first and second link mechanisms, and which also increases the swing (slide) resistance of the head part generated when the head part swings about the second swing axis.

Two of first link mechanisms may be provided and separated from each other in the longitudinal direction of the shaving portion. A shaft configured to rotatably support the head part may be bridged between a first link arm of one of the two first link mechanisms and a first link arm of the other first link mechanism. Two longitudinal end portions of the shaft may be fixed to the corresponding first link aims of the respective two first link mechanisms. A longitudinal center portion of the shaft may be fixed to the head part.

According to this configuration, when the head part swings about the first swing axis, the shaft twists and thus generates a reactive force (torque) against the swing. Hence, it is possible to obtain swing load torque with a relatively simple configuration.

Two of first link mechanisms may be provided and separated from each other in the longitudinal direction of the shaving portion. The two first link mechanisms may be provided independently of each other. Each pair of the first connecting axes corresponding between the two first link mechanisms may be concentrically arranged.

According to this configuration, it is possible to form a simple configuration, as compared to a case where two first link mechanisms are formed integratedly.

The first link mechanism may include a first support arm configured to rotatably support the two first link arms. The first support arm may include an attachment having a flat portion intersecting with an imaginary plane orthogonal to the first swing axis. The attachment may be fixed to the interposer with the flat portion placed against the interposer.

According to this configuration, the portions where the flat portions abut against the interposer receive a force caused by a swing of the head part and acting on the attachment portions of the first support arms. Consequently, misalignment of the first support arms from the interposer due to the swing of the head part is suppressed, and thus the support stiffness of the interposer for the first support arms is easily secured.

The second link mechanism may include a base and paired second support arms projecting respectively from two sides, in a direction of the second swing axis, of the base. Each of the two second link arms may be bridged rotatably between the paired second support arms.

According to this configuration, the second link mechanism is formed spatially, which helps to increase the stiffness and strength thereof.

Each of the two second link arms may be bridged in a U shape between the paired second support arms. The interposer may be attached to a bottom portion of the U shape of each of the two second link arms.

According to this configuration, it is possible to obtain a configuration which is relatively simple but still allows the two second link arms to be connected to the interposer concentrically and rotatably.

The electric shaver may further comprise an elastic member configured to apply a reactive force against a swing of the interposer with respect to the body part. Here, the elastic member may be bridged between the body part and the interposer from one side to another side in the direction of the second swing axis.

According to this configuration, it is possible to secure a necessary reactive force against swing about the second swing axis, and thus to further prevent the head part from swinging easily only about the second swing axis. In addition, a sufficient length of the elastic member can be secured easily, which in turn allows a high flexibility in setting the level of the reactive force against swing.

The electric shaver may further comprise: a first biasing mechanism configured to apply a reactive force against a swing of the head part with respect to the interposer; and a second biasing mechanism configured to apply a reactive force against a swing of the interposer with respect to the body part. Here, torque obtained by the reactive force from the second biasing mechanism may be larger than torque obtained by the reactive force from the first biasing mechanism.

According to this configuration, it is possible to further prevent the head part from swinging easily only about the second swing axis Ax. Consequently, a further improved following performance of the head part on a shaving area can be exerted.

### BRIEF DESCRIPTION OF THE DRAWINGS

FIG. 1 is a perspective view of an electric shaver according to an embodiment of the present invention.

FIG. 2 is an exploded perspective view of the electric shaver according to the embodiment of the present invention.

FIG. 3 is a perspective view of a head part of the electric shaver according to the embodiment of the present invention, and shows the head part with an outer case removed therefrom.

FIG. 4 is an exploded perspective view showing an interposer, first link mechanisms, and part of the head part, all of which are included in the electric shaver according to the embodiment of the present invention.

FIG. 5 is a perspective view showing a second link mechanism, the interposer, and part of the first link mechanisms, all of which are included in the electric shaver according to the embodiment of the present invention.

FIG. 6 is a side view (a view seen from a Y direction) showing the second link mechanism, the interposer, the first link mechanisms, and part of the head part, all of which are included in the electric shaver according to the embodiment of the present invention.

FIG. 7 is a front view (a view seen from an X direction) showing the second link mechanism, the interposer, the first link mechanisms, and part of the head part, all of which are included in the electric shaver according to the embodiment of the present invention.

FIG. 8 is a perspective view (a view seen from a body part side in a Z direction) showing the second link mechanism, the interposer, the first link mechanisms, and part of the head part, all of which are included in the electric shaver according to the embodiment of the present invention.

FIG. 9 is a perspective view (a view seen from the body part side in the Z direction) showing the second link mechanism, the interposer, the first link mechanisms, and part of the head part, all of which are included in an electric shaver according to a modification of the embodiment of the present invention.

### DETAILED DESCRIPTION OF THE EMBODIMENT

Hereinbelow, an embodiment of the present invention will be described in detail with reference to the drawings. Note that similar components are included in the following embodiment and its modifications, and therefore will be denoted below by common reference characters and duplicate description thereof will be omitted. In addition, in the following, an X direction, a Y direction, and a Z direction in the drawings will be referred to a front-to-rear direction, a right-to-left direction, and a top-to-bottom direction, respectively, for convenience of explanation.

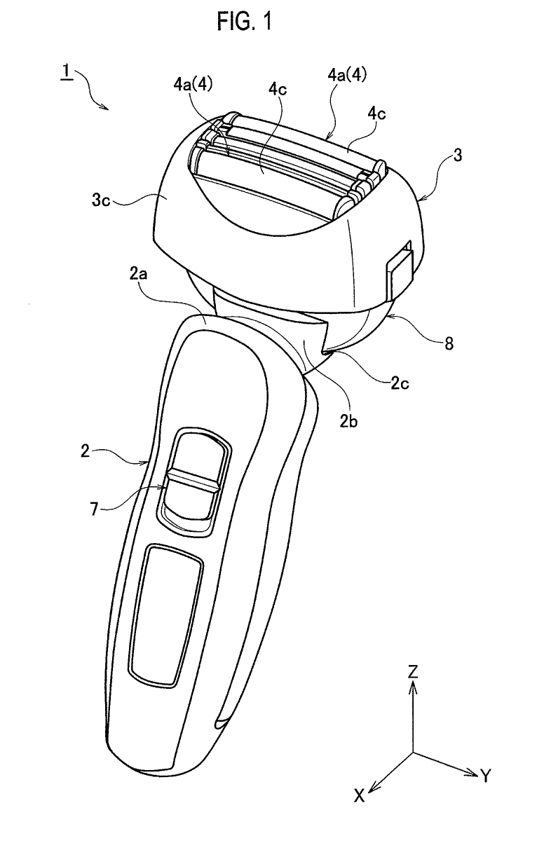

As shown in FIG. 1, an electric shaver 1 according to the embodiment of the present invention includes a rod-shaped body part 2 and a head part 3 swingably attached to an end portion 2a on one longitudinal side (the upper side of FIG. 1) of the body part 2.

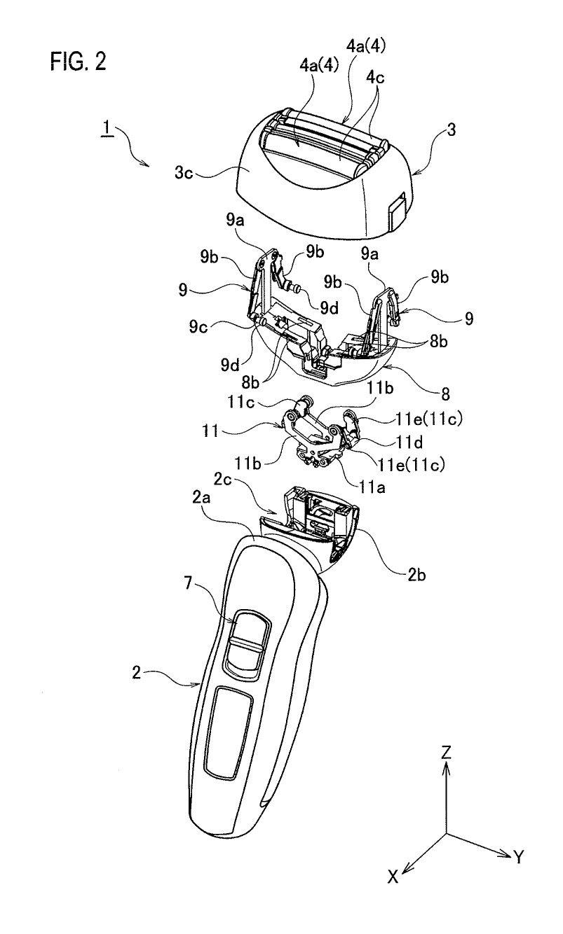

In this embodiment, as shown in FIGS. 1 and 2, a projecting portion 2b which is expanded laterally (in the X direction) is formed at the end portion 2a on the one longitudinal side of the body part 2. The head part 3 is attached to the projecting portion 2b. The head part 3 projects from the body part 2 in the Z direction in FIGS. 1 and 2 (=a projecting direction, or the upper side of FIGS. 1 and 2) while being in a free state; i.e., no swinging force is acting thereon.

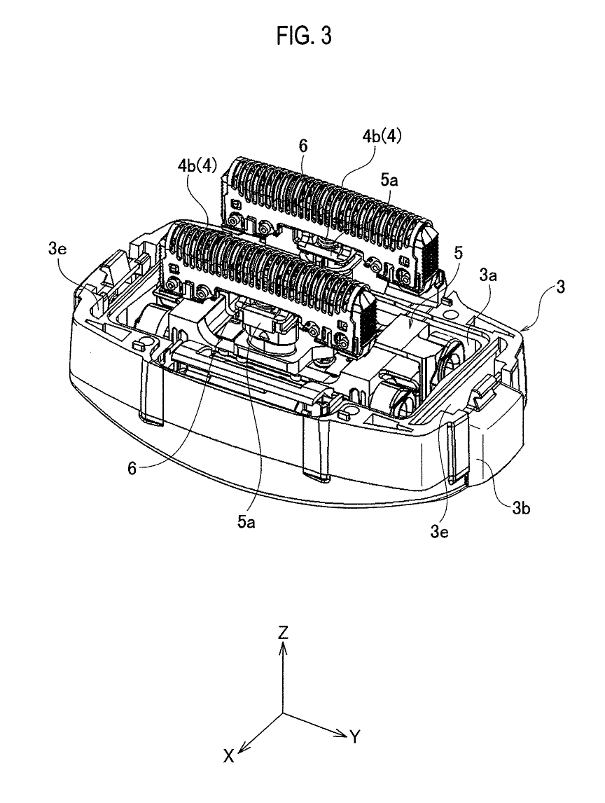

As shown in FIGS. 2 and 3, the head part 3 is provided with multiple (two in this embodiment) shaving portions 4 which are elongated in one direction (the Y direction) approximately orthogonal to the projecting direction (the Z direction) and which are parallel with each other. Each of the shaving portions 4 includes, as paired blades, an outer blade 4a (FIG. 2) which is exposed at the tip of the head part 3 and is formed in a mesh pattern, and an inner blade 4b (FIG. 3) which is configured to reciprocate in sliding contact with the inner surface of the outer blade 4a. The shaving portion 4 is configured so that hair let in the shaving portions 4 via openings in the mesh pattern of the outer blade 4a would be cut between the inner surface of the outer blade 4a and the outer surface of the inner blade 4b. The outer surfaces of the outer blades 4a serve as contact surfaces 4c. In this embodiment, each outer blade 4a is fixed to the head part 3, whereas each inner blade 4b is configured to be reciprocally driven in a longitudinal direction of its shaving portion 4 (i.e., the Y direction) by a drive mechanism 5 configured for example as a linear motor. This configuration allows a relative action by a pair of the outer blade 4a and the inner blade 4b, which in turn produces the above cutting function. Note that, in this embodiment, the two inner blades 4b are configured to reciprocate in opposite phases in the Y direction.

The head part 3 includes a head case 3b (FIG. 3) having a concave portion 3a in the shape of a bottomed square cylinder and an outer case 3c (FIG. 2) configured to cover the opening side of the head case 3b. The drive mechanism 5 is housed in the concave portion 3a. The inner blades 4b are attached to movable portions 5a of the drive mechanism 5, respectively, whereas the outer blades 4a are attached to the outer case 3c. The inner blades 4b are pressed against the respective outer blades 4a from the inside (the lower side of FIGS. 2 and 3) when the outer case 3c having the outer blades 4a attached thereto are brought to cover and be attached to the head case 3b having the drive mechanism 5 and the inner blades 4b attached thereto. Incidentally, appropriate pressing forces can be applied between the inner blades 4b and the outer blades 4a by biasing mechanisms 6, such for example as coil springs, attached to the movable portions 5a, respectively.

As shown in FIGS. 1 and 2, an operation part 7 is provided on a surface of the body part 2. The user's manipulation of the operation part 7 allows switching between actuation and de-actuation of the drive mechanism 5. The body part 2 houses a battery as a power source of the drive mechanism 5, a converter configured to convert an AC power to a DC power, a drive circuit configured to drive the drive mechanism 5, and the like. To shave hair, such as a beard, the user activates the drive mechanism 5, by manipulating the operation part 7, to thus reciprocate the inner blades 4b; and moves the electric shaver 1 along a skin (shaving area) while holding the body part 2 and pressing the contact surfaces 4c of the outer blades 4a at the tip of the head part 3 against the skin.

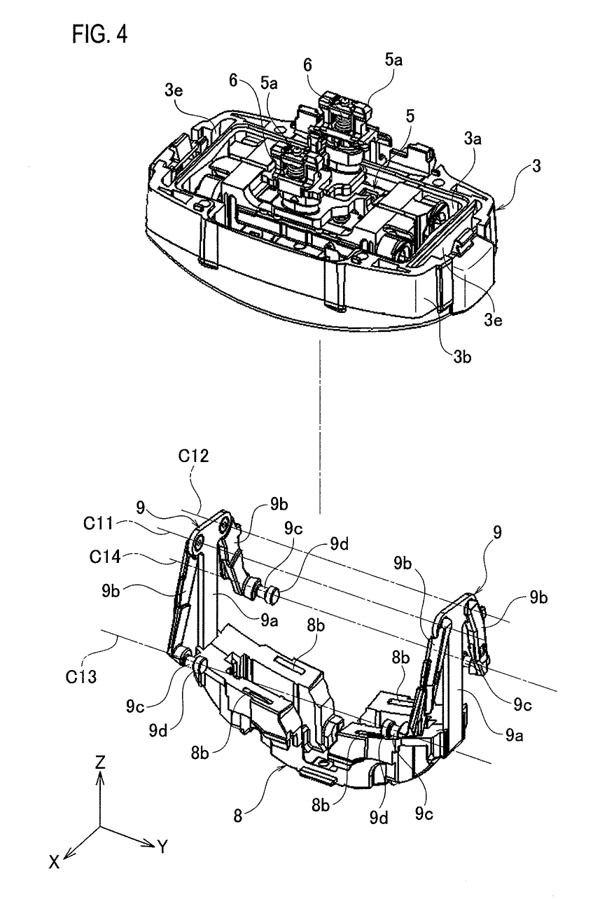

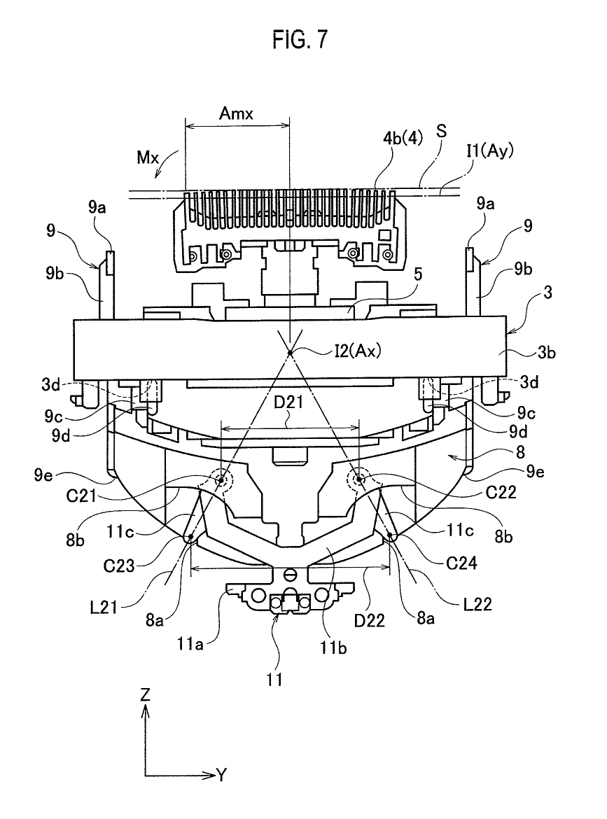

In this embodiment, as shown in FIGS. 2, 4, and so on, an interposer 8 is provided between the body part 2 and the head part 3. The interposer 8 is configured to be swingably supported by the body part 2 and also to swingably support the head part 3. Specifically, the interposer 8 supports the head part 3 swingably about a first swing axis Ay (FIG. 7, etc.) approximately parallel with the longitudinal direction of the shaving portions 4 (i.e., the Y direction). Moreover, the interposer 8 is supported by the body part 2 (FIG. 7, etc.) swingably about a second swing axis Ax which is approximately orthogonal to the projecting direction of the head part 3 (i.e., the Z direction) and also extends in a direction (the X direction) orthogonal to the first swing axis Ay.

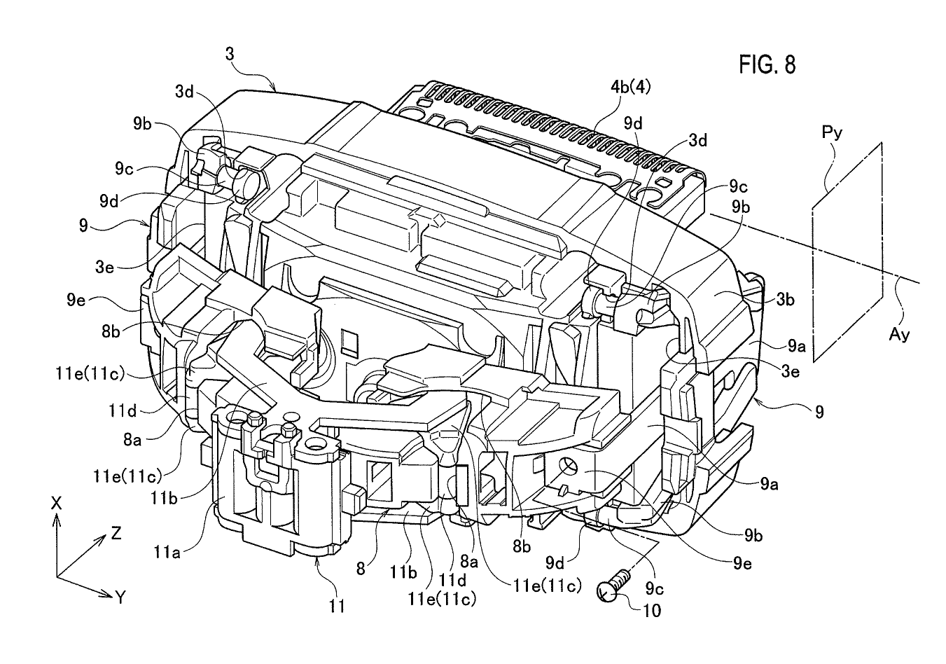

The head part 3 is supported by the interposer 8 with first link mechanisms 9 therebetween. As shown in FIGS. 2, 4, and so on, there are provided two first link mechanisms 9 which are separated in the longitudinal direction of the shaving portions 4 (i.e., the Y direction). Each of the first link mechanisms 9 includes: an approximately T-shaped first support arm 9a which is fixed to an end portion, in the Y direction, of the interposer 8 and projects in the Z direction; and two first link arms 9b which are rotatably connected to one Z-direction side (a side closer to the tip of the head part 3, or the upper side of FIG. 4) of the first support arm 9a, and which are separated in the X direction. An approximately-cylindrical protrusion 9c projecting toward the center, in the Y direction, of the head part 3 is provided to the other Z-direction side (a side closer to the body part 2, or the lower side of FIG. 4) of each first link arm 9b. The protrusion 9c is provided with an enlarged diameter portion 9d. As shown in FIG. 8, receivers 3d are formed on the other Z-direction side (a near side of FIG. 8) of the head part 3. Each receiver 3d is in a concavoconvex shape (a stepped, semicylindrical concave portion, for example) corresponding to the protrusion 9c and the enlarged diameter portion 9d. The protrusion 9c and the enlarged diameter portion 9d as well as the receiver 3d are configured in such a way that the protrusion 9c and the enlarged diameter portion 9d can be fitted into the receiver 3d while at least one of the protrusion 9c and the enlarged diameter portion 9d or the receiver 3d is elastically deformed and mutually approaches each other in the Z direction. In this embodiment, the fitted state of these portions allows the protrusion 9c and the enlarged diameter portion 9d to be supported by the receiver 3d rotatably about the Y direction. In other words, in this embodiment, each of the first link arms 9b is rotatably connected to both the interposer 8 and the body part 2.

As shown in FIG. 4, the two first link mechanisms 9 have symmetrical configurations on the right and left sides. Thus, the first link arms 9b are disposed so that each pair of connecting axes C11 to C14 corresponding between the two right and left first link mechanisms 9 can be concentric. Here, the connecting axes C11 to C14 extend in the Y direction and are used for connection of the first link arms 9b to the interposer 8 or the body part 2.

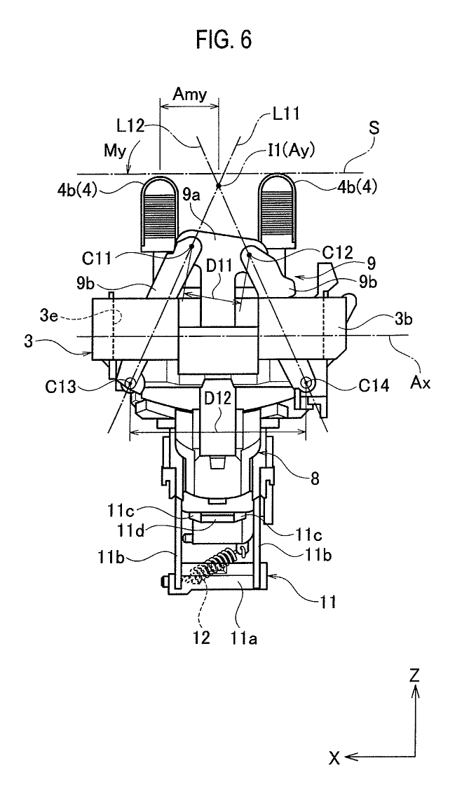

Thus, in this embodiment, as shown in FIG. 6, the first link mechanisms 9 form a planar four-link mechanism in which the head part 3 and the interposer 8 (or the first support arms 9a fixed thereto) are rotatably connected to the two first link arms 9b in four portions at the four connecting axes C11 to C14 extending in the Y direction.

As shown in FIG. 6, in this embodiment, a distance D11 between the connecting axes C11 and C12 for connection of the link arms 9b to the interposer 8 (the first support arm 9a fixed to the interposer 8 in this embodiment) is made shorter than a distance D12 between the connecting axes C13 and C14 for connection of the first link arms 9b to the head part 3. Further, when viewed in the Y direction (i.e., in the view of FIG. 6), each of the first link mechanisms 9 is configured so that an intersection I1 of a straight line L11 (which joins the connecting axes C11 and C13 for one of the first link arms 9b) with a straight line L12 (which joins the connecting axes C12 and C14 for the other first link arm 9b) can be located near the position of a tip portion S (indicated by a chain line in FIGS. 6 and 7), in the projecting direction (the Z direction), of the contact surface 4c of the outer blade 4a of each shaving portion 4 disposed on the side closer to the tip, in the Z direction, of the head part 3. In this configuration, the intersection I1 may be considered as the first swing axis Ay in the state shown in FIG. 6 (the free state).

In each of the first link mechanisms 9 according to this embodiment, the distance D11 is set shorter than the distance D12 as mentioned above. If they were set equal to each other, the first link mechanism would be parallelogram, which permits only parallel movement of the contact surfaces 4c of the head part 3 and thus makes it impossible to obtain a swing action. Meanwhile, if the distance D11 were set longer than the distance D12, the first swing axis Ay would get away from the contact surfaces 4c. This causes the contact surfaces 4c to slide on a shaving area when the head part 3 swings, which increases the swing resistance. That is to say, in this embodiment, by setting the distance D11 shorter than the distance D12, a smoother swing action about the first swing axis Ay is obtained.

In this embodiment, as shown in FIGS. 3, 4, 6, 8, and so on, thin slits 3e are formed respectively in both end portions, in the Y direction, of the head case 3b so as to penetrate in the Z direction and be approximately orthogonal to the Y direction. The first support arms 9a and the first link arms 9b can be inserted into the slits 3e from the other Z-direction side (from the lower side of FIGS. 4 and 6), thereby to penetrate the head case 3b in the Z direction. This configuration implements the above-described layout (see FIG. 6) in which the connecting axes C11 and C12 for connection to the interposer 8 are located closer to the one Z-direction side (the side closer to the tip of the head part 3) than the connecting axes C13 and C14 for connection to the head part 3 are to thus dispose the intersection I1 (the first swing axis Ay) near the tip portion S, in the projecting direction (the Z direction), of each contact surface 4c. This configuration also makes it possible to improve the assemblability of the first link mechanisms 9.

In this embodiment, as shown in FIG. 8, each of the first support arms 9a is provided with an attachment 9e having a flat portion (a rear surface of the attachment 9e in the view of FIG. 8) which intersects with (or, in this embodiment, is orthogonal to) an imaginary plane Py (see the XZ plane in FIG. 8) orthogonal to the first swing axis Ay. With the flat portions abutting against the interposer 8, the attachments 9e are fixed to the interposer 8 with screws 10. This configuration allows the portions (where the flat portions abut against the interposer 8) to receive a force caused by the swing of the head part 3 and acting on the attachment portions of the first support arms 9a. Consequently, misalignment of the first support arms 9a from the interposer 8 due to the swing is suppressed. Moreover, even if the first support arms 9a are fixed with the screws 10, it is possible to suppress loosening of the screws 10 due to the swing of the head part 3.

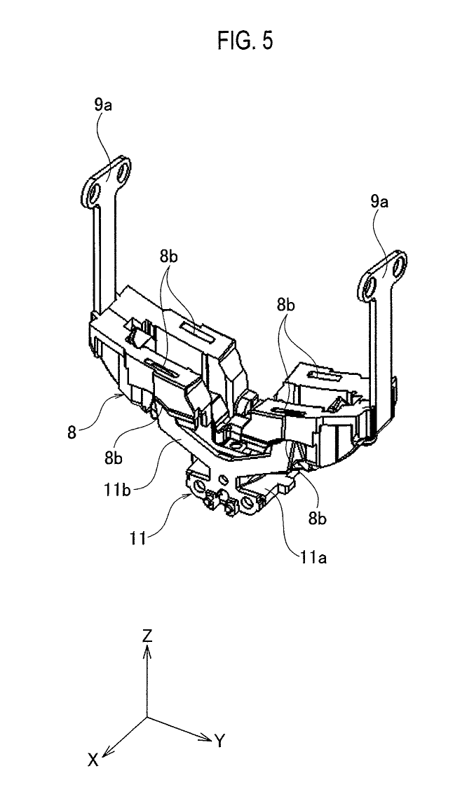

The interposer 8 is supported by the body part 2 with a second link mechanism 11 therebetween. As shown in FIG. 2, the second link mechanism 11 is, for example, screwed or fitted to, in other words, fixed to the projecting portion 2b while being housed inside a concave portion 2c formed in the projecting portion 2b of the body part 2. Moreover, as shown in FIGS. 2, 5, 8, and so on, the second link mechanism 11 includes: a base 11a in the shape of an approximately-rectangular flat plate; two second support arms 11b projecting in approximately Y-shapes toward the one Z-direction side (the side closer to the tip of the head part 3) respectively from both end portions, in the X direction, of the base 11a; and two second link arms 11c bridged between the two second support arms 11b. The two second link arms 11c are disposed away from each other in the Y direction and connected to the second support arms 11b respectively so as to be rotatable about connecting axes C 21 and C22 extending in the X direction (FIG. 7).

The second link arms 11c are each formed in an approximately U-shape when viewed in the Y direction. Portions of each second link arm 11c on the opening side of the U shape are rotatably supported by the second support arms 11b, respectively, whereas the interposer 8 is rotatably attached to a bottom portion 11d of the U shape. In this embodiment, the bottom portion 11d in an approximately cylindrical shape is bridged between a pair of side portions 11e of each second link arm 11c so as to be rotatable about the axis thereof. Also, the bottom portion 11d is fitted and thus attached to a receiver 8a formed as an approximately-cylindrical concave portion in a bottom portion of the interposer 8, by bringing the bottom portion 11d closer to the receiver 8a from the other Z-direction side (the near side of FIG. 8). In other words, in this embodiment, the central axes of the bottom portions 11d serve respectively as connecting axes C23 and C24 (FIG. 7) extending in the X direction.

Thus, in this embodiment, as shown in FIG. 7, the second link mechanism 11 forms a planar four-link mechanism in which the interposer 8 and the body part 2 (or the second support arms 11b fixed thereto) are rotatably connected to the two second link arms 11c) in four portions at the four connecting axes C21 to C24 extending in the X direction.

As shown in FIG. 7, as in the case of the first link mechanisms 9 described above, the second link mechanism 11 is also configured so that a distance D21 between the connecting axes C21 and C22 for connection of the second link arms 11c to the body part 2 (in this embodiment, the second support arms 11b fixed to the body part 2) would be shorter than a distance D22 between the connecting axes C23 and C24 for connection of the second link arms 11c to the interposer 8. Further, when viewed in the X direction (i.e., in the view of FIG. 7), the second link mechanism 11 is configured so that an intersection 12 of a straight line L21 (which joins the connecting axes C21 and C23 for one of the second link arms 11c) with a straight line L22 (which joins the connecting axes C22 and C24 for the other second link arm 11c) can be located farther away from the position of the tip portion S, in the projecting direction (the Z direction), of the contact surface 4c of the outer blade 4a of each shaving portion 4, than the intersection I1 for the first link arms 9b is. In this configuration, the intersection 12 may be considered as the second swing axis Ax in the state shown in FIG. 7 (the free state).

In other words, in this embodiment, the second swing axis Ax (the intersection 12) is located away from the tip portion S, in the projecting direction (the Z direction), of the contact surface 4c of each shaving portion 4, the contact surface 4c being to be brought into contact with a shaving area. Thus, swinging the head part 3 about the second swing axis Ax causes the contact surfaces 4c to move (slide) along the shaving area, hence generating swing resistance.

Here, in the electric shaver 1 having the shaving portions 4 elongated in the Y direction as described in this embodiment, a moment arm Amx (FIG. 7) of the head part 3 swinging about the second swing axis Ax is longer than a moment arm Amy (FIG. 6) of the head part 3 swinging about the first swing axis Ay. Thus, a swing torque (turning moment) Mx (FIG. 7) about the second swing axis Ax is likely to be larger than a swing torque (turning moment) My (FIG. 6) about the first swing axis Ay. This creates a situation where it is easier for the head part 3 to swing about the second swing axis Ax but difficult to swing about the first swing axis Ay, if no countermeasures are taken. This might lower the following performance of the head part 3 exerted during swing on an uneven shaving area when the head part 3 is moved along the shaving area.

Meanwhile, in this embodiment, as described above, the second swing axis Ax (the intersection 12) is located farther away from the contact surface 4c of each shaving portion 4, than the first swing axis Ay (the intersection I1) is, the contact surface 4c being to be brought into contact with the shaving area. Thus, sliding between the contact surfaces 4c and the shaving area due to swinging of the head part 3 increases the swing (slide) resistance of the head part 3 in swing about the second swing axis Ax, thereby preventing the head part 3 from swinging easily only about the second swing axis Ax. Consequently, an improved following performance of the head part 3 on the shaving area can be exerted.

Moreover, in this embodiment, as shown in FIG. 6, a coil spring 12 is provided between the body part 2 (or, in this embodiment, the base 11a) and the interposer 8, as a second biasing mechanism configured to apply a reactive force against the swing of the head part 3 with respect to the body part 2 (swing of the interposer 8 with respect to the body part 2). The coil spring 12 is an elastic member bridged from one side to the other side in the direction of the second swing axis Ax. This coil spring 12 makes it possible to secure a necessary reactive force against the swing about the second swing axis Ax, and thus to further prevent the head part 3 from swinging easily only about the second swing axis Ax. In addition, the disposition of the coil spring 12 in the direction of the second swing axis Ax helps to secure a sufficient length of the coil spring 12, which in turn allows a high flexibility in setting the level of the reactive force against swing.

In this embodiment, the coil spring 12 as the second biasing mechanism is attached between the base 11a and the interposer 8. It is therefore possible to obtain the state where the second biasing mechanism is interposed between the body part 2 and the interposer 8 by attaching the coil spring 12 at the time of assembling the second link mechanism 11 and the interposer 8 together, and then by fixing the assembly (of the base 11a of the second link mechanism 11) to the body part 2. Such a configuration can reduce the amount of work required for the attachment, as compared with the case of directly installing the second biasing mechanism between the body part 2 and the interposer 8.

In this embodiment, as shown in FIGS. 2, 4, 5, 7, 8, and so on, slits 8b are formed in the interposer 8 also as in the case of the above-described first link mechanisms and head case 3b. Into the slits 8b, the second support arms 11b and the second link arms 11c are inserted. The slits 8b are configured in such a way to allow the second support arms 11b and the second link arms 11c to be inserted therethrough from the other Z-direction side (from the lower side of FIGS. 4, 5, and 7) and thereby to penetrate the interposer 8 in the Z direction. This configuration implements the above-described layout (FIG. 6) in which the connecting axes C11 and C12 for connection to the interposer 8 are located closer to the one Z-direction side (the side closer to the tip portion of the head part 3) than the connecting axes C13 and C14 for connection to the head part 3 are to thus dispose the intersection I1 (the first swing axis Ay) near the contact surfaces 4c. The configuration also makes it possible to improve the assemblability of the first link mechanisms 9.

As has been described above, in this embodiment, the second swing axis Ax is located farther away from the tip portion S, in the projecting direction (the Z direction), of the contact surface 4c of each shaving portion 4, than the first swing axis Ay is, the contact surface 4c being to be brought into contact with the shaving area. Thus, when the head part 3 swings about the second swing axis Ax, the contact surfaces 4c move (slide) a longer distance along the shaving area, which increases the swing resistance. Specifically, in the case where the head part 3 swings about the second swing axis Ax, the swing torque My becomes larger as the moment arm Amy becomes longer; however, the swing load torque can be increased by the slide resistance, thereby preventing the head part 3 from swinging easily only about the second swing axis Ax. Consequently, an improved following performance of the head part 3 on the shaving area can be exerted.

In this embodiment, the head part 3 is supported on the interposer 8 with the first link mechanisms 9 therebetween so as to be swingable about the first swing axis Ay, and the interposer 8 is supported on the body part 2 with the second link mechanism 11 therebetween so as to be swingable about the second swing axis Ax. Accordingly, for example, with certain arrangement of the first link arms 9b and the second link arms 11c (the positions of the connecting axes and the angles of the link arms, for example), it is possible to obtain, in a relatively simple manner, a configuration which allows the head part 3 to swing about the first and second swing axes Ay and Ax, and which also increases the swing (slide) resistance of the head part 3 generated when the head part 3 swings about the second swing axis Ax.

In this embodiment, the first link mechanisms 9 are configured in such a way that: two first link mechanisms 9 are provided and separated from each other in the Y direction; each pair of the connecting axes C11 to C14 corresponding between the two first link mechanisms 9 is concentrically arranged; and the respective two first link mechanisms 9 are separated into two parts. Accordingly, it is possible to form a simple configuration, as compared to a case where two first link mechanisms 9 are formed integratedly.

In this embodiment, the first support arm 9a of each first link mechanism 9 is provided with the attachment 9e having the flat portion which intersects with the imaginary plane Py orthogonal to the first swing axis Ay. With the flat portions abutting against the interposer 8, the attachments 9e are fixed to the interposer 8. Thereby, the portions where the flat portions abut against the interposer 8 receive a force caused by the swing of the head part 3 and acting on the attachment portions of the first support arms 9a. Consequently, misalignment of the first support arms 9a from the interposer 8 due to the swing of the head part 3 is suppressed, and thus the support stiffness of the interposer 8 for the first support arms 9a is easily secured.

In this embodiment, the second link mechanism 11 is configured to include the base 11a, the paired second support arms 11b, and the two second link arms 11c bridged between the paired second support arms 11b. This allows the second link mechanism 11 to be formed spatially and thus helps to increase the stiffness and strength thereof. In addition, the amount of assembly work can be reduced, as compared to the case where second link mechanisms 11 are provided separately in the X direction.

In this embodiment, the two second link arms 11c are each bridged in an approximately U-shape between the paired second support arms 11b, and the interposer 8 is attached to the bottom portion 11d of the approximately U shape. This makes it possible to obtain a configuration which is relatively simple but still allows the two second link arms 11c to be connected to the interposer 8 concentrically and rotatably. In addition, the amount of assembly work can be reduced.

In this embodiment, the coil spring 12 is provided between the body part 2 and the interposer 8, as the second biasing mechanism configured to apply a reactive force against the swing of the head part 3 with respect to the body part 2. The coil spring 12 is an elastic member bridged from one side to the other side in the direction of the second swing axis Ax. Accordingly, it is possible to secure a necessary reactive force against the swing about the second swing axis Ax, and thus to further prevent the head part 3 swinging easily only about the second swing axis Ax. In addition, a sufficient length of the coil spring 12 can be secured easily, which in turn allows a high flexibility in setting the level of the reactive force against swing.

(Modification)

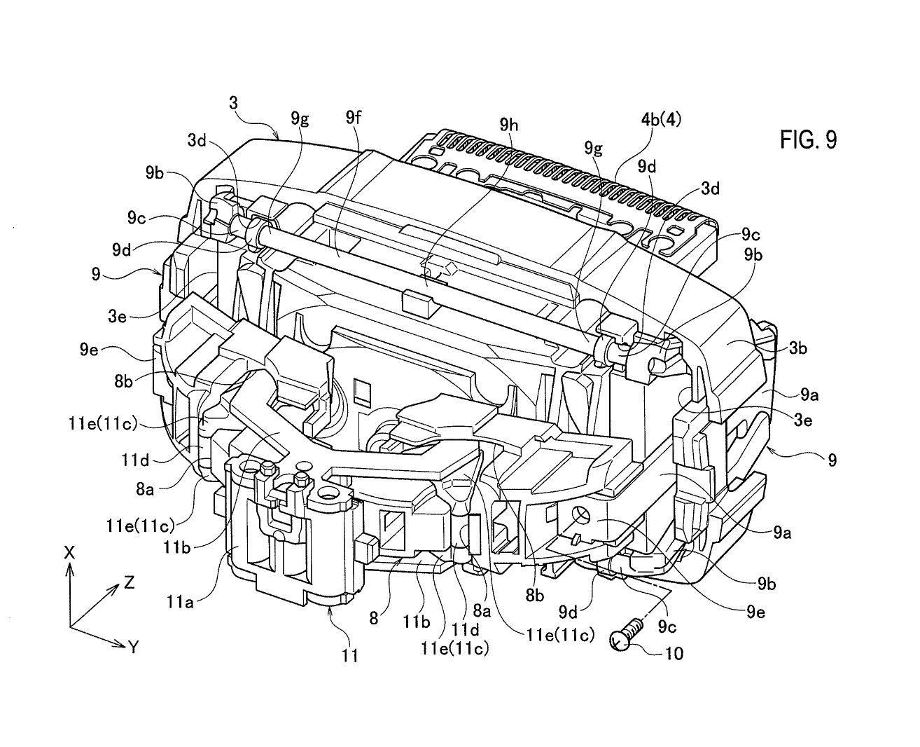

In a modification of the above-described embodiment, as shown in FIG. 9, a shaft 9f configured to rotatably support the head part 3 is bridged between the first link arm 9b of one of the two first link mechanisms and the first link arm 9b of the other one of the first link mechanisms 9 that are separated from each other in the Y direction. Moreover, two longitudinal end portions 9g of the shaft 9f are fixed to the first link arms 9b, respectively. Furthermore, a longitudinal center portion 9h of the shaft 9f is fixed to the head part 3. The two longitudinal end portions 9g respectively have the similar shape to or the same shape as the protrusions 9c and the enlarged diameter portions 9d of the above-described embodiment. Thus, the two longitudinal end portions 9g are supported by the receivers 3d so as to be rotatable about the Y direction. Meanwhile, the longitudinal center portion 9h is fixed, for example, by being fitted, welded, bonded, or screwed to the head part 3. For this reason, the shaft 9f functions as a torsion bar configured to twist between the longitudinal center portion 9h and each of the two longitudinal end portions 9g. When the head part 3 swings about the first swing axis Ay, the shaft 9f twists and thus provides a reactive force (torque) against swing. In other words, according to this modification, it is possible to obtain swing load torque about the first swing axis Ay with a relatively simple configuration. The shaft 9f corresponds to a first biasing mechanism configured to apply a reactive force against the swing of the head part 3 with respect to the interposer 8.

In such a configuration, it is preferable that the reactive torque about the second swing axis Ax generated by the coil spring 12 as the second biasing mechanism be set greater than the reactive torque about the first swing axis Ay generated by the shaft 9f as the first biasing mechanism. By doing so, it is possible to further prevent the head part 3 from swinging easily only about the second swing axis Ax. Consequently, a further improved following performance of the head part 3 on the shaving area can be exerted.

One embodiment of the present invention has been described above, but the present invention is not limited to the above embodiment, and various modifications are possible.

For example, in the above embodiment, a configuration is illustrated in which the head part is supported on the interposer with the first link mechanisms therebetween, and the interposer is supported on the body part with the second link mechanism therebetween; however, mechanisms other link mechanisms may be employed as the swing support mechanisms. Also, the specifications (such as the positions, sizes, or configurations) of the first link mechanisms and second link mechanism are not limited to the ones in the above embodiment.

In addition, mechanisms or members other than a coil spring and a torsion bar (a shaft) may be employed as the first and second biasing mechanisms.

What is claimed is:

1. An electric shaver comprising:
a body part;
a head part swingably attached to one end portion, in a longitudinal direction, of the body part, the head part including a shaving portion and a drive mechanism, the shaving portion being formed to be elongated in a second direction orthogonal to a first direction in which the head part projects and having pairs of an inner blade and an outer blade arranged in rows in a third direction orthogonal to the first and second directions, the drive mechanism being configured to cause a relative movement between the inner blade and the outer blade of each of the pairs; and
an interposer configured to support the head part swingably about a first swing axis parallel with the second direction, and to be supported on the body part swingably about a second swing axis orthogonal to the first direction and orthogonal to the first swing axis,
wherein the first swing axis is located, in the third direction, between tip portions, in the first direction, of the outer blades of the pairs in rows at one end and the other end of the rows in the third direction, and
wherein the second swing axis is located farther away from the tip portions in the first direction than the first swing axis is.

2. The electric shaver according to claim 1, further comprising:
a first link mechanism including two first link arms each connected to the interposer and the head part respectively at first connecting axes parallel with the second direction, the first link mechanism configured to support the head part on the interposer swingably about the first swing axis; and
a second link mechanism including two second link arms each connected to the body part and the interposer respectively at second connecting axes orthogonal to the first direction and orthogonal to the first swing axis, the second link mechanism configured to support the interposer on the body part swingably about the second swing axis, wherein
a distance between the first connecting axes for connection of the two first link arms to the interposer is shorter than a distance between the first connecting axes for connection of the two first link arms to the head part,
a distance between the second connecting axes for connection of the two second link arms to the body part is shorter than a distance between the second connecting axes for connection of the two second link arms to the interposer, and
an intersection of a first straight line with a second straight line is located closer to an opposite end portion, in the longitudinal direction, of the body part, than an intersection of a third straight line with a fourth straight line is, the first straight line joining the second connecting axes for one of the two second link arms, the second straight line joining the second connecting axes for the other second link arm, the third straight line joining the first connecting axes for one of the two first link arms, the fourth straight line joining the first connecting axes for the other first link arm.

3. The electric shaver according to claim 2, wherein
two of first link mechanisms are provided and separated from each other in the second direction,
a shaft configured to rotatably support the head part is bridged between a first link arm of one of the two first link mechanisms and a first link arm of the other first link mechanism,
two longitudinal end portions of the shaft are fixed to the corresponding first link arms of the respective two first link mechanisms, and
a longitudinal center portion of the shaft is fixed to the head part.

4. The electric shaver according to claim 2, wherein
two of first link mechanisms are provided and separated from each other in the second direction,
the two first link mechanisms are provided independently of each other, and
each pair of the first connecting axes corresponding between the two first link mechanisms is concentrically arranged.

5. The electric shaver according to claim 2, wherein
the first link mechanism includes a first support arm configured to rotatably support the two first link arms,
the first support arm includes an attachment having a flat portion intersecting with an imaginary plane orthogonal to the first swing axis, and
the attachment is fixed to the interposer with the flat portion placed against the interposer.

6. The electric shaver according to claim 2, wherein
the second link mechanism includes
a base and
paired second support arms projecting respectively from two sides, in a direction of the second swing axis, of the base, and
each of the two second link arms is bridged rotatably between the paired second support arms.

7. The electric shaver according to claim 6, wherein
each of the two second link arms is bridged in a U shape between the paired second support arms, and
the interposer is attached to a bottom portion of the U shape of each of the two second link arms.

8. The electric shaver according to claim 6, further comprising an elastic member configured to apply a reactive force against a swing of the interposer with respect to the body part,
wherein the elastic member is bridged between the body part and the interposer from one side to another side in the direction of the second swing axis.

9. The electric shaver according to claim 2, further comprising:
a first biasing mechanism configured to apply a reactive force against a swing of the head part with respect to the interposer; and
a second biasing mechanism configured to apply a reactive force against a swing of the interposer with respect to the body part,
wherein torque obtained by the reactive force from the second biasing mechanism is larger than torque obtained by the reactive force from the first biasing mechanism.
